(19) United States
(12) Patent Application Publication
(10) Pub. No.: US 2020/0236843 A1
(43) Pub. Date: Jul. 30, 2020

(54) PLANTING SYSTEM FOR CONTROLLING SEED DEPTH AND METHODS OF USE

(71) Applicant: Graham Equipment, LLC, Sterling, CO (US)

(72) Inventors: Jerry D. Graham, Wray, CO (US); Marty Graham, Naples, FL (US); Warren Edwin Guthrie, West Olive, MI (US); John Gregory Videtich, Zeeland, MI (US)

(21) Appl. No.: 16/752,161

(22) Filed: Jan. 24, 2020

Related U.S. Application Data
(60) Provisional application No. 62/918,322, filed on Jan. 25, 2019.

(51) Int. Cl. A01C 7/20; A01C 5/04; A01C 7/12

(52) U.S. Cl. CPC A01C 7/203; A01C 7/127; A01C 5/04

(57) ABSTRACT

A system and methods for controlling the seed depth of a row planter utilizing sensed angle data from an angle sensor operably connected to a gauge wheel, the angle data corresponding to the height of the planter frame above the soil surface. The system comprises a piston assembly operably connected to a pump controlled by a processor. The processor is configured to actuate the pump based on the sensed angle data transmitted to the processor. The piston assembly configured to pivot the planter frame through and about a link assembly connected between the piston assembly and the planter frame. Methods for controlling seed depth utilizing sensed angle data from an angle sensor operably connected to a gauge wheel.

### CROSS-REFERENCE TO RELATED APPLICATIONS

This present non-provisional patent application claims priority to an earlier-filed provisional patent application titled A PRECISION PLANTING SYSTEM FOR CONTROLLING SEED DEPTH BASED ON A GROUND CONTACTING SENSOR, U.S. Provisional Patent Application Ser. No. 62/918,322, filed Jan. 25, 2019. The contents of the identified earlier-filed application are hereby incorporated by reference in their entirety.

### TECHNICAL FIELD

The disclosed subject matter relates generally to a planting system and more particularly, but not necessarily exclusively, to a system for planting seeds at a controlled seed depth.

### BACKGROUND

Modem agricultural methods use mechanical planters to immerse seeds into the soil for germination. At a basic level, the process consists of (1) cutting a furrow, (2) dropping a seed into the furrow, and (3) covering the seed with soil. At face value, this seems simple enough, but certain things are apt to go wrong. For example, seeds might be too deep and so not emerge. Seeds might be too shallow and so not receive sufficient moisture. The weight on the wheels of the mechanical planter might over-compact the soil and so stunt root growth.

A common type of mechanical planters use a gauge that sets the seed depth. The gauge is a measurement taken between the planter load-bearing wheels (also called gauge wheels) and the sharp furrow-cutting wheel. Seed depth is set by the immersion of the cutting wheel into the soil, and the immersion of the seed will be consistent as long at the gauge wheels maintain contact with the soil surface, which can be accommodated by placing a large weight on the gauge wheels. Yet, as discussed above, large weight can over-compact the soil. In contrast, too little weight will cause the gauge wheels to bounce off the soil so that seeds are planted too shallow. With this basis, an ideal weight is just enough to maintain gauge wheel ground contact without the wheels bouncing off irregularities in the soil.

One solution to the root-confinement problem is to adjust the weight on the wheels according to the soil conditions. This is referred to as down-force control. Down-force control is presently accomplished with hydraulic or pneumatic pistons that are set to apply force as predetermined by the user.

Fundamentally, down-force control is a means to remotely adjust the weight applied to a mechanical planter and so requires knowledge of the required weight needed to maintain the cutting wheel depth. However, the required weight may change depending on soil type and conditions.

As such, down-force control has two deficiencies that the present invention intends to resolve: (1) to work optimally, down-force control requires knowledge of the soil consistency, which might change over the course of planting; (2) down-force control often applies more than the required weight to maintain cutting wheel depth and so over-compacts the soil which in turn negatively impacts the root systems of the germinated seeds.

As such, there is a need for a precision seed depth control system that controls the seed depth independent of the soil type and minimizes the force on the planter gauge wheels.

### SUMMARY

The disclosed subject matter is directed towards a planting system for controlling the seed depth for a row planter utilizing angle data from an angle sensor operably connected to a gauge wheel, the angle data corresponding to the height of the planter frame above soil surface. An embodiment of the disclosed subject matter includes a system for planting seeds. The system includes (1) a row unit, comprising: a front plate; a planter frame; a gauge wheel connected to the planter frame, the gauge wheel configured to engage a surface; a cutting wheel connected to the planter frame, the cutting wheel configured to form a furrow having a depth in the surface; a link assembly pivotally connecting the planting frame to the front plate; a piston assembly connected to the front plate, comprising: a pump; and a piston operably connected to the pump, the piston connected to the link assembly, wherein the piston is configured to pivot the planter frame; and an angle sensor operably connected to the gauge wheel for calculating a first distance between the planter frame and the surface; and (2) a controller having a processor, the controller being operably connected to the piston assembly and the angle sensor; whereby the depth of the furrow is adjusted by pivoting the planter frame through actuation of the pump via the controller in response to data from the angle sensor.

In some embodiments, the processor may be configured to calculate an angular value corresponding to a difference between a sensed angle and a reference angle, wherein the reference angle corresponds to a predetermined depth of the furrow, and wherein the sensed angle corresponds to the first distance. The processor may further be configured to control actuation of the pump based on the calculated angular value.

In another embodiment, the link assembly includes an upper link and a lower link, the upper link and the lower link may be of approximately equal length.

In another embodiment, the lower link is connected to the piston, whereby movement of the piston results in rotation of the planter frame about the upper link.

In another embodiment, the system includes a transmitter configured to transmit real-time angle data from the angle sensor to the controller.

In another embodiment, the planter frame may include a closing wheel configured to urge soil into the furrow. The system may additionally include a feed chute configured to dispose a plurality of seeds into the furrow prior to closing the furrow with soil by the closing wheel.

The disclosed subject matter is further directed towards a method for adjusting a seed depth. The method may include the steps of: providing the above-described system; calculating by the processor an angular value corresponding to a difference between a sensed angle and a reference angle; wherein the reference angle corresponds to a predetermined depth of the furrow; and wherein the sensed angle corresponds to the first distance; and controlling actuation of the pump based on the angular value; whereby the depth of the furrow is adjusted through movement of the cutting wheel by pivoting the planter frame about the link assembly.

In another embodiment, the method for adjusting a seed depth may include the steps: of moving the row unit across the surface; and transmitting angle data from the angle sensor to the controller for processing.

In another embodiment, the method for adjusting a seed depth may include the steps of: depositing a plurality of seeds within the furrow; and urging soil into the furrow by the closing wheel.

In yet another embodiment, a methods for adjusting a seed depth may include the steps of: controlling movement of the piston by the processor based on angle data generated by the angle sensor; and adjusting the cutting wheel either upwardly or downwardly through movement of the lower link connected to the piston.

### BRIEF DESCRIPTION OF THE DRAWINGS

The present disclosed subject matter is described herein with reference to the following drawing figures, with greater emphasis place on clarity rather than scale:

FIG. 1 is a schematic view of an embodiment of the disclosed subject matter.

FIG. 2 is a schematic view of an embodiment of the disclosed subject matter.

FIG. 3 is a schematic view of an embodiment of the disclosed subject matter.

FIG. 4 is a flow chart of a method of use of an embodiment of the disclosed subject matter.

FIG. 5 is a flow chart of a method of use of an embodiment of the disclosed subject matter.

### DETAILED DESCRIPTION

As required, detailed aspects of the disclosed subject matter are disclosed herein; however, it is to be understood that the disclosed aspects are merely exemplary of the disclosed subject matter, which may be embodied in various forms. Therefore, specific structural and functional details disclosed herein are not to be interpreted as limiting, but merely as a basis for the claims and as a representative basis for teaching one skilled in the art how to variously employ the disclosed technology in virtually any appropriately detailed structure.

Certain terminology will be used in the following description, and are shown in the drawings, and will not be limiting. For example, up, down, front, back, right and left refer to the disclosed subject matter as orientated in the view being referred to. The words, “inwardly” and “outwardly” refer to directions toward and away from, respectively, the geometric center of the aspect being described and designated parts thereof. Upwardly and downwardly are generally in reference to the direction of travel, if appropriate. Said terminology will include the words specifically mentioned, derivatives thereof and words of similar meaning.

The disclosed subject matter will now be described with reference to the drawing figures, in which like reference numerals refer to like parts throughout. For purposes of clarity in illustrating the characteristics of the present disclosed subject matter, proportional relationships of the elements have not been maintained in the figures. In some cases, the sizes of certain small components have been exaggerated for illustration.

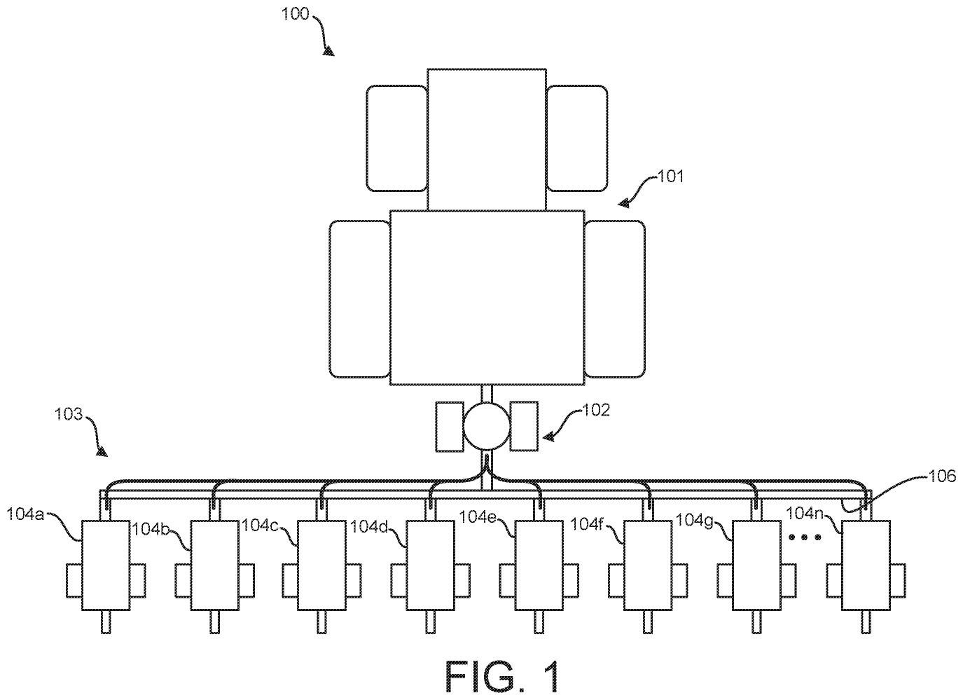

Referring to FIG. 1, in an embodiment of the disclosed subject matter, a planting system 100 comprises a tractor 101 connected to one or more planters 104a-n via a tool bar 106. A pump 102 may be connected to the planters 104a-n via a hose 103. The pump 102 may comprise a hydraulic pump or pneumatic pump in order to distribute a pressurized air or pressurized fluid thorough the set of hoses 103a-n to the set of planters 104a-n.

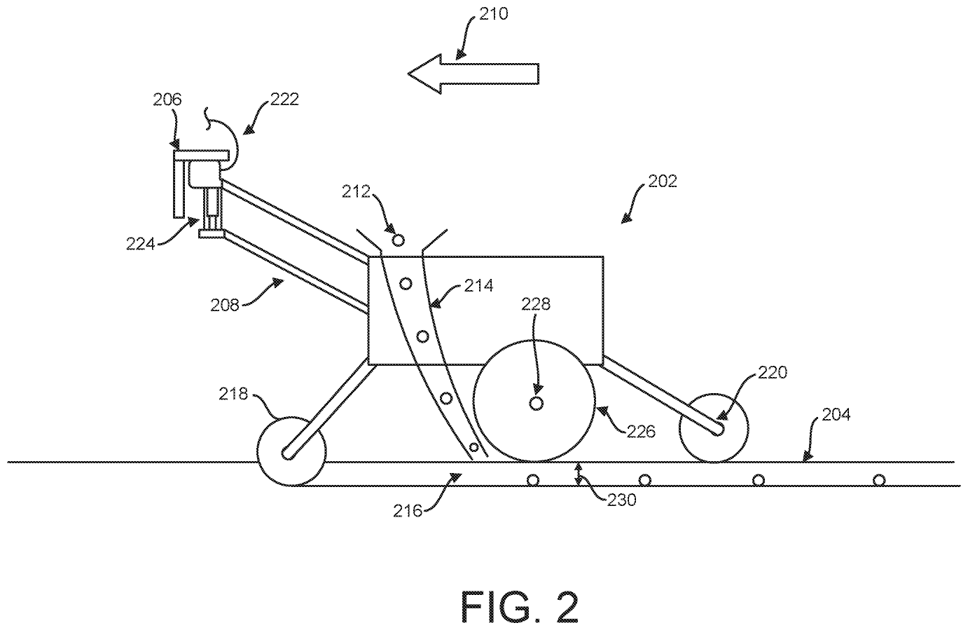

Referring to FIG. 2, in an embodiment of the disclosed subject matter, a planter 202 rests on a soil surface 204. The planter 202 is connected to a tool bar 206 via a hinge 208. The tool bar 206 configured to pull the planter 202 in a direction of travel 210. A plurality of seeds 212 are feed through a feed chute 214 into a furrow 216 created by a cutting wheel 218. A closing wheel 220 pushes soil over the furrow 216 after the plurality of seeds 212 are deposited into the furrow 216. High pressure fluid or air is supplied by a hose 222 connected to a pump on the tractor 101 (shown in FIG. 1). The high pressure fluid or air supplies a piston 224 which applies force as set by the user to a gauge wheel 226. The piston 224 may be hydraulic or pneumatic. The total force is the combination of the force of gravity plus the force from the piston 224. The total force is measured by a load cell 228 disposed between the gauge wheel 226 and the planter 202. The total force is used to adjust the pressure of the fluid or air from the piston 224 and subsequently adjust the final seed depth 230.

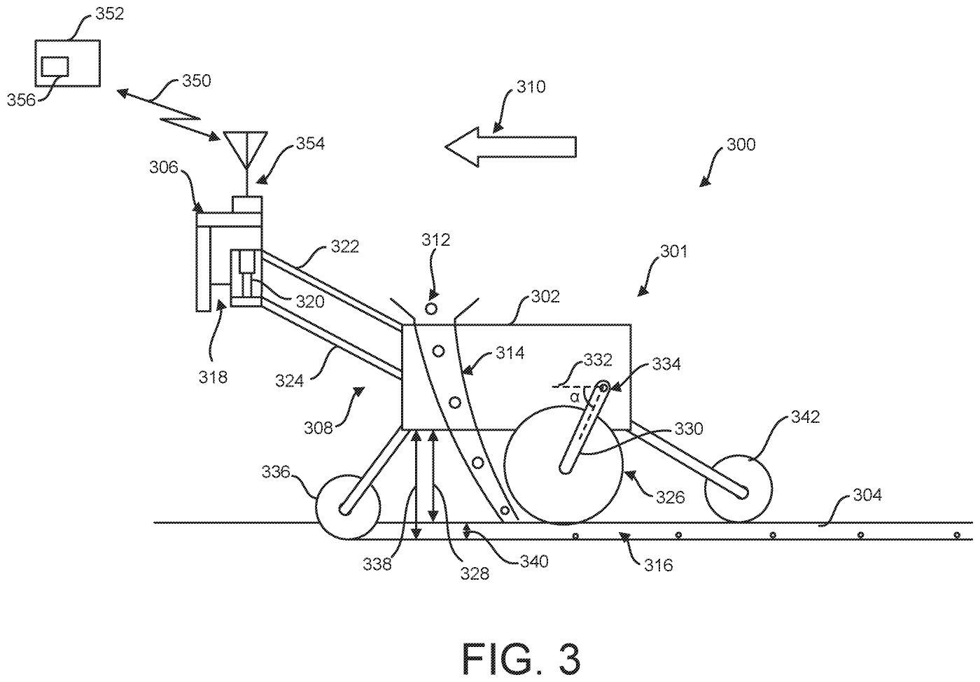

Referring to FIG. 3, in an embodiment of the disclosed subject matter, a system 300 for planting seeds comprises a row unit 301 configured to travel across a soil surface 304 in a direction of travel 310. The row unit 301 further comprising a front plate 306 and a planter frame 302 connected to the front plate 306 by means of a link assembly 308 pivotally connecting the planter frame 302 to the front plate 306. In some embodiments of the disclosed subject matter, the link assembly 308 may comprise an upper link 322 and a lower link 324. In an embodiment of the disclosed subject matter, the upper link 322 comprises a first length, and the lower link 324 comprises a second length; wherein the first length and the second length are approximately equal. In additional embodiments, the first length and the second length may be different.

The front plate 306 is configured to pull the row unit 301 in a direction of travel 310 over surface 304. A plurality of seeds 312 may be feed through a feed chute 314 and deposited into a furrow 316 created by a cutting wheel 336 connected to the planter frame 302. A closing wheel 342 may be connected to the planter frame 302; wherein the closing wheel is configured to urge soil into the furrow 316 after the plurality of seeds 312 is deposited into the furrow 316.

The cutting wheel 336 may be connected to the planter frame 302 at a second distance 338 below the planter frame 302. The furrow 316 may be formed by the cutting wheel 336 as the row until 301 moves in the direction of travel 310 through the surface 304. The furrow 316 extending a depth 340 below the soil surface 304. The depth 340 is approximately the difference between the second distance 338 and the first distance 328. The planter frame 302 may pivoted about the upper link 322 in a manner that the depth 340 may be adjusted but the cutting wheel 336.

In an embodiment of the disclosed subject matter, a piston assembly 318 may be connected to the front plate 306. The piston assembly 318 may comprise a pump (not shown) and a piston 320 operably connected to the pump; wherein the piston 320 is configured to pivot the planter frame 302 through movement of the piston 320 via the link assembly 308. For example, the lower link 324 may be moved downwardly by the piston 320 in order to pivot the planter frame 302 about the upper link 322; whereby the depth 340 of the furrow 316 is increased by driving the cutting wheel 336 deeper below the soil surface 304. Alternatively, the lower link 324 may be moved upwardly by the piston 320 in order to pivot the planter frame 302 about the upper link 322; whereby the depth 340 of the furrow 316 is decreased though upward movement of the cutting wheel 336 in the soil surface 304.

In an embodiment of the disclosed subject matter, the row unit 301 may comprise a gauge wheel 326 connected to the planter frame 302, wherein the gauge wheel 326 is configured to engage the soil surface 304, and wherein the gauge wheel 326 is further configured to move towards or away from the planter frame 302. A first distance 328 is defined between the soil surface 304 and planter frame 302. In some embodiments, a gauge member 330 may be rotatably connected to the gauge wheel 326 and the planter frame 302 at the opposite distal ends of the gauge member 330, so that an angle α is formed between the gauge member 330 and a reference line 332. Since the gauge member 330 connects the gauge wheel 326 and planter frame 302, angle α is proportional to the first distance 328, and angle α may be used to calculate the first distance 328.

In an embodiment of the disclosed subject matter, the row unit 301 may comprise an angle sensor 334 operably connected to the gauge wheel 326 for sensing the angle α and calculating the first distance 328 between the planter frame 302 and soil surface 304. The sensed angle data 350 corresponding to the angle α may be transmitted to a controller 352 via a transmitter 354 for processing by a processor 356.

In an embodiment of the disclosed subject matter, the processor 356 is configured to calculate an angular value corresponding to a difference between a sensed angle corresponding the sensed angle data 350 and a reference angle; wherein the reference angle corresponds to a depth 340 of the furrow 316; and wherein the sensed angle corresponds to the first distance 328; and control actuation of the pump via the controller in response to the angular value.

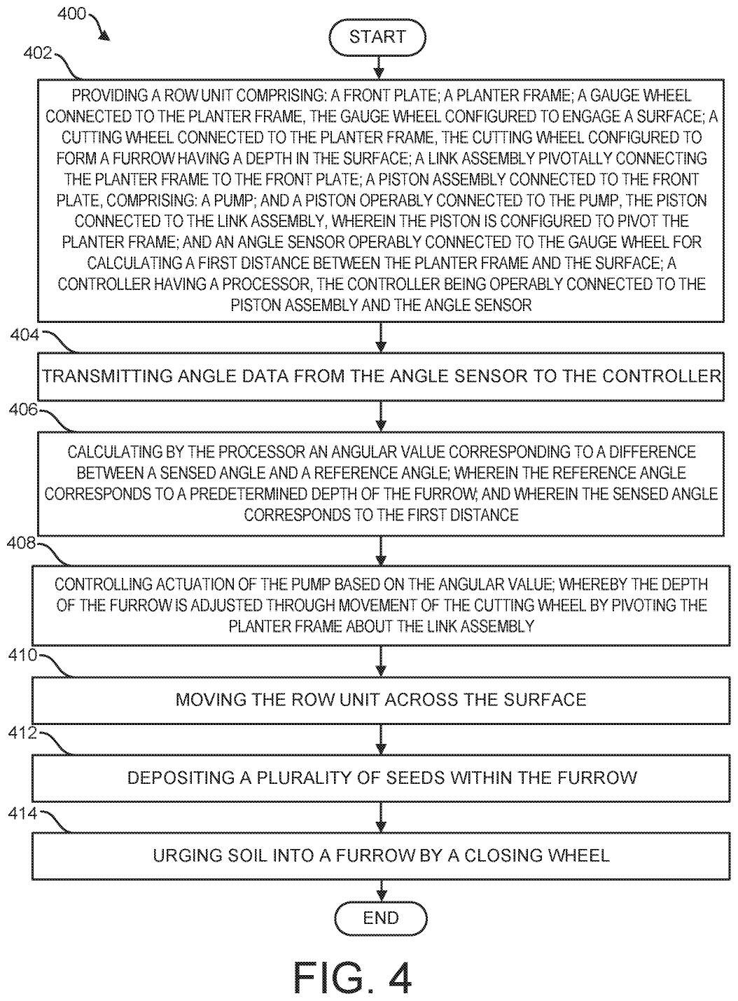

Referring to FIG. 4, in some embodiments of the disclosed subject matter, a method 400 for controlling a seed depth comprises the step of providing, at step 402, a row unit comprising: a front plate; a planter frame; a gauge wheel connected to the planter frame, the gauge wheel configured to engage a surface; a cutting wheel connected to the planter frame, the cutting wheel configured to form a furrow having a depth in the surface; a link assembly pivotally connecting the planter frame to the front plate; a piston assembly connected to the front plate, comprising: a pump; and a piston operably connected to the pump, the piston connected to the link assembly, wherein the piston is configured to pivot the planter frame; and an angle sensor operably connected to the gauge wheel for calculating a first distance between the planter frame and the surface; a controller having a processor, the controller being operably connected to the piston assembly and the angle sensor. At step 404, the method 400 comprises transmitting angle data from the angle sensor to the controller. At step 406, the method 400 comprises the step of calculating by the processor an angular value corresponding to a difference between a sensed angle and a reference angle; wherein the reference angle corresponds to a predetermined depth of the furrow; and wherein the sensed angle corresponds to the first distance. At step 408, the method 400 comprises the step of controlling actuation of the pump based on the angular value; whereby the depth of the furrow is adjusted through movement of the cutting wheel by pivoting the planter frame about the link assembly. At step 410, the method 400 comprises the step of moving the row unit across the surface. At step 412, the method 400 further comprises the step of depositing a plurality of seeds within the furrow. At step 414, the method 400 comprises, wherein the row unit further comprises a closing wheel configured to urge soil into the furrow, the step of urging soil into the furrow after the depositing step.

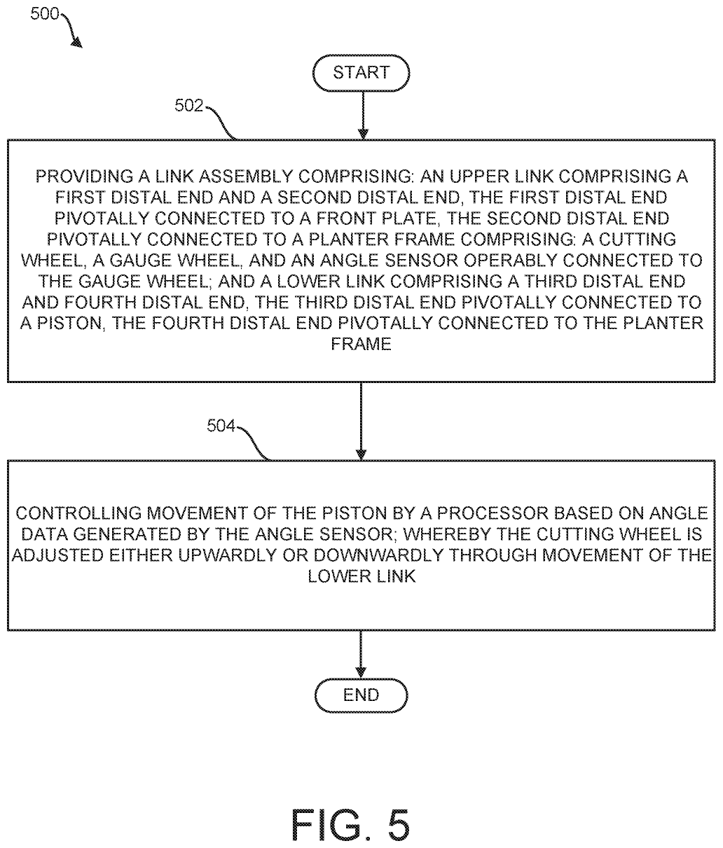

Referring to FIG. 5, in some embodiments of the disclosed subject matter, a method 500 for controlling a seed depth comprises, at step 502, the step of providing a link assembly comprising: an upper link comprising a first distal end and a second distal end, the first distal end pivotally connected to a front plate, the second distal end pivotally connected to a planter frame comprising: a cutting wheel, a gauge wheel, and an angle sensor operably connected to the gauge wheel; and a lower link comprising a third distal end and fourth distal end, the third distal end pivotally connected to a piston, the fourth distal end pivotally connected to the planter frame. At step 504, the method 500 comprises the step of controlling movement of the piston by a processor based on angle data generated by the angle sensor; whereby the cutting wheel is adjusted either upwardly or downwardly through movement of the lower link.

Although the subject matter has been disclosed with reference to various particular embodiments, it is understood that equivalents may be employed and substitutions made herein without departing from the scope of the disclosed subject matter as recited in the claims.

It is to be understood that while certain aspects of the disclosed subject matter have been shown and described, the disclosed subject matter is not limited thereto and encompasses various other embodiments and aspects.

Having described the disclosed subject matter, what is claimed as new and desired to be secured by Letters Patent is:

1. A system for planting seeds, comprising:
a row unit, comprising:
a front plate;
a planter frame;
a gauge wheel connected to the planter frame, the gauge wheel configured to engage a surface;
a cutting wheel connected to the planter frame, the cutting wheel configured to form a furrow having a depth in the surface;
a link assembly pivotally connecting the planter frame to the front plate;
a piston assembly connected to the front plate, comprising:
a pump; and
a piston operably connected to the pump, the piston connected to the link assembly, wherein the piston is configured to pivot the planter frame; and
an angle sensor operably connected to the gauge wheel for calculating a first distance between the planter frame and the surface; and
a controller having a processor, the controller being operably connected to the piston assembly and the angle sensor;
whereby the depth of the furrow is adjusted by pivoting the planter frame through actuation of the pump via the controller in response to data from the angle sensor.

2. The system of claim 1, wherein the processor is configured to:
calculate an angular value corresponding to a difference between a sensed angle and a reference angle; wherein the reference angle corresponds to a predetermined depth of the furrow; and wherein the sensed angle corresponds to the first distance; and
control actuation of the pump based on the angular value.

3. The system of claim 1, wherein the link assembly comprises:
an upper link having a first length; and
a lower link having a second length; wherein the first length and the second length are approximately equal.

4. The system of claim 3, wherein the lower link is connected to the piston; whereby movement of the piston rotates the planter frame about the upper link.

5. The system of claim 1, further comprising a transmitter configured to transmit angle data from the angle sensor to the controller.

6. A system of claim 1, wherein the row unit further comprises a closing wheel connected to the planter frame.

7. A system of claim 1, wherein the row unit further comprises a feed chute configured to dispose a plurality of seeds into the furrow.

8. A system for planting seeds, comprising:
a row unit, comprising:
a front plate;
a planter frame;
a gauge wheel connected to the planter frame, the gauge wheel configured to engage a surface;
a cutting wheel connected to the planter frame, the cutting wheel configured to form a furrow having a depth in the surface;
a link assembly pivotally connecting the planter frame to the front plate;
the link assembly comprising:
an upper link having a first length; and
a lower link having a second length; wherein the first length and the second length are approximately equal;
a piston assembly connected to the front plate, comprising:
a pump; and
a piston operably connected to the pump, the piston connected to the link assembly, wherein the piston is configured to pivot the planter frame; and
an angle sensor operably connected to the gauge wheel for calculating a first distance between the planter frame and the surface; and
a controller having a processor, the controller being operably connected to the piston assembly and the angle sensor;
whereby the depth of the furrow is adjusted by pivoting the planter frame through actuation of the pump via the controller in response to data from the angle sensor.

9. The system of claim 8, wherein the processor is configured to:
calculate an angular value corresponding to a difference between a sensed angle and a reference angle; wherein the reference angle corresponds to a predetermined depth of the furrow; and wherein the sensed angle corresponds to the first distance; and
control actuation of the pump based on the angular value.

10. The system of claim 8, wherein the lower link is connected to the piston;
whereby movement of the piston rotates the planter frame about the upper link.

11. The system of claim 8, further comprising a transmitter configured to transmit angle data from the angle sensor to the controller.

12. A method for adjusting a seed depth, comprising the steps of:
providing a row unit, comprising:
a front plate;
a planter frame;
a gauge wheel connected to the planter frame, the gauge wheel configured to engage a surface;
a cutting wheel connected to the planter frame, the cutting wheel configured to form a furrow having a depth in the surface;
a link assembly pivotally connecting the planter frame to the front plate;
a piston assembly connected to the front plate, comprising:
a pump; and
a piston operably connected to the pump, the piston connected to the link assembly, wherein the piston is configured to pivot the planter frame; and
an angle sensor operably connected to the gauge wheel for calculating a first distance between the planter frame and the surface; and
a controller having a processor, the controller being operably connected to the piston assembly and the angle sensor;
calculating by the processor an angular value corresponding to a difference between a sensed angle and a reference angle; wherein the reference angle corresponds to a predetermined depth of the furrow; and wherein the sensed angle corresponds to the first distance; and
controlling actuation of the pump based on the angular value; whereby the depth of the furrow is adjusted through movement of the cutting wheel by pivoting the planter frame about the link assembly.

13. The method of claim 12, further comprising the step of moving the row unit across the surface.

14. The method of claim 13, further comprising the step of depositing a plurality of seeds within the furrow.

15. The method of claim 14, wherein the row unit further comprises a closing wheel configured to urge soil into the furrow.

16. The method of claim 15, further comprising the step of urging soil into the furrow after the depositing step.

17. The method of claim 12, further comprising the step of transmitting angle data from the angle sensor to the controller having a processor.

18. The method of claim 12, wherein the link assembly further comprises: an upper link pivotally connected to the front plate and the planter frame; and a lower link pivotally connected to the piston and the planter frame.

19. The method of claim 18, further comprising the step of controlling movement of the piston by the processor based on angle data generated by the angle sensor.

20. The method of claim 19, further comprising the step of adjusting the cutting wheel either upwardly or downwardly through movement of the lower link.
